(19) United States
(12) Patent Application Publication
(10) Pub. No.: US 2012/0017476 A1
(43) Pub. Date: Jan. 26, 2012

(54) GREEN ENERGY SIGN LAMP

(76) Inventor: JIA-YUAN LEE, TAIPEI (TW)

(21) Appl. No.: 12/840,558

(22) Filed: Jul. 21, 2010

(51) Int. Cl. G09F 13/04; H01M 10/46

(52) U.S. Cl. 40/564; 320/101

(57) ABSTRACT

A green energy sign lamp includes a lamp box and a wind power generation device. The lamp box includes an LED light emitting source, at least one advertising billboard, a current conversion module and a battery. The LED light emitting source, the current conversion module and the battery are installed in the lamp box, and the advertising billboard is installed on a side of the lamp box. A support stand on a lateral side of the lamp box is provided for installing the wind power generation device axially, and a fixed portion on another lateral side of the lamp box is provided for fixing the lamp box, so that electric energy produced by the wind power generation device starts up the LED light emitting source to emit light to achieve an advertising effect, or the electric energy is charged into the battery for its use when there is no wind.

### BACKGROUND OF THE INVENTION

1. Field of the Invention

The present invention relates to an area of advertising, and more particularly to an advertising signal lamp using green energy source such as wind or solar energy as its electric power source.

2. Description of the Related Art

To achieve the effects of marketing, advertising and publicity, an advertising lamp or a sign lamp is usually used for exhibiting pictures, service descriptions, and brand names of desired promoting products, and the advertising lamp or sign lamp has the effect of emitting light to transmit the aforementioned information to consumers at night time.

With reference to FIG. 1 for a schematic view of a conventional advertising lamp or sign lamp, the advertising lamp or sign lamp 10 generally comprises a lamp box 11 provided for containing a control circuit board 12 and at least one light emission source 13, wherein the control circuit board 12 is electrically coupled to the light emission source(s) 13, and a light emitting surface 111 is disposed on at least one side of the lamp box 11, and a translucent board 14 is installed at a position corresponding to the light emitting surface 111, such that the light emission source 13 is disposed at a position corresponding to the translucent board 14, and the control circuit board 12 is electrically coupled to an external electric power source 20. The electrically connected advertising lamp or sign lamp 10 displays a pattern or a text through the translucent board 14 by using the light produced by the light emission source 13, so as to achieve the effect of transmitting information at night time. However, the advertising lamp or sign lamp 10 of this sort is usually connected to the external electric power source 20, and it is necessary to have a new circuit layout for the construction of the lamp. Obviously, it is inconvenient to manufacturers. Furthermore, the application incurs a higher cost for the electric power consumption, and fails to comply with the concept of energy saving and carbon reduction.

In view of the shortcomings of the conventional advertising lamp or sign lamp 10, the present invention provides a green energy sign lamp capable of using wind and/or solar energy to supply electric energy required by a light emission source of the sign lamp, meeting the green energy requirements of the environmental protection, and lowering the cost for the electric power consumption. In addition, the modular design of the present invention facilitates the installation and application of the lamp and reduces the construction cost.

### SUMMARY OF THE INVENTION

Therefore, it is a primary objective of the invention to overcome the aforementioned shortcomings and deficiencies of the prior art by providing a green energy sign lamp having a modular design to facilitate its installation and application, so as to reduce the construction cost and the electric power consumption.

Another objective of the present invention is to provide a green energy sign lamp combined with the use of other green energy sources to provide various different power utilization methods and more extensive applications of the lamp.

To achieve the foregoing objectives, the present invention provides a green energy sign lamp, comprising: a lamp box, including an LED light emitting source, at least one advertising billboard, a current conversion module and a battery, wherein the LED light emitting source, the current conversion module and the battery are installed in the lamp box, and the current conversion module are electrically coupled to the LED light emitting source and the battery, and the advertising billboard is installed on a side of the lamp box, and a lateral side of the lamp box has a support stand and a fixed portion; and a wind power generation device, axially installed in the support stand, and electrically coupled to the current conversion module, wherein the support stand includes two symmetric fixed plates for installing the wind power generation device between the two fixed plates. In addition, the wind power generation device further comprises a vane wheel and an electricity generator, and the vane wheel includes a shaft and a plurality of vanes, and the shaft is connected to the electricity generator, and the vane wheel can be rotated to start the electricity generator for generating electric energy.

Therefore, the present invention uses the wind power generation device installed on a side of the lamp box to drive the vane wheel to produce mechanical energy after the vane wheel is rotated by wind, and the electricity generator is operated to generate electric energy for driving the LED light emitting source to emit light and light up the advertising billboard or store the electric energy into the battery.

To achieve the foregoing objectives, the support stand installed on the lamp box of the present invention is disposed at a lateral edge of a symmetric side of the fixed portion, or the support stand is installed at a lateral edge of an adjacent connecting side of the fixed portion to provide a more flexible design and cope with an aesthetic requirement for different designs, such that the lamp can be adjusted according to the requirements of the installation site. The invention not only facilitates the installation of the lamp, but also reduces the construction cost of the lamp.

To achieve the foregoing objectives, the green energy sign lamp of the present invention further includes a solar power generation device electrically coupled to the current conversion module, and sunlight is used for generating electric energy to start up the LED light emitting source to emit light or store the electric energy into the battery, wherein the solar power generation device is installed at the top of the lamp box and provided for absorbing solar energy from the sunlight, such that both wind and solar energy can be used for generating electric energy to achieve the effects of supplying electric power, and providing an extensive application of the green energy sign lamp.

### BRIEF DESCRIPTION OF THE DRAWINGS

FIG. 1 is a schematic perspective view of a conventional advertising lamp or sign lamp;

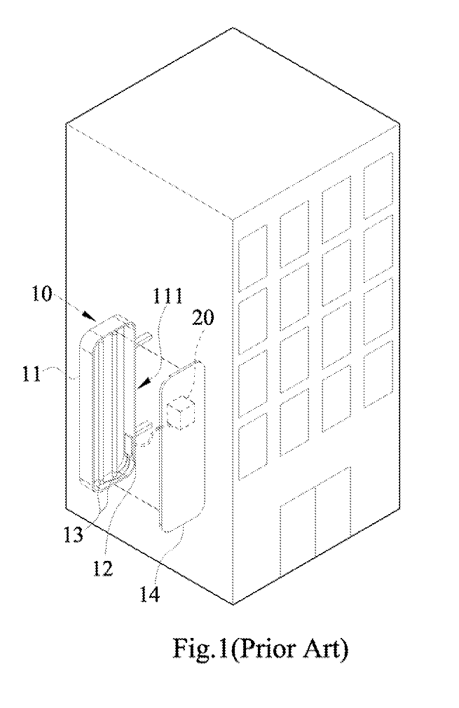

FIG. 2 is an exploded view of a preferred embodiment of the present invention;

FIG. 3 is a perspective view of a preferred embodiment of the present invention;

FIG. 4 is a first schematic view of another preferred embodiment of the present invention;

FIG. 5 is a second schematic view of another preferred embodiment of the present invention;

FIG. 6 is a third schematic view of another preferred embodiment of the present invention;

FIG. 7 is a fourth schematic view of another preferred embodiment of the present invention; and

FIG. 8 is a perspective view of another preferred embodiment of the present invention.

### DETAILED DESCRIPTION OF THE PREFERRED EMBODIMENTS

The technical characteristics of the present invention will become apparent with the detailed description of preferred embodiments and the illustration of related drawings as follows.

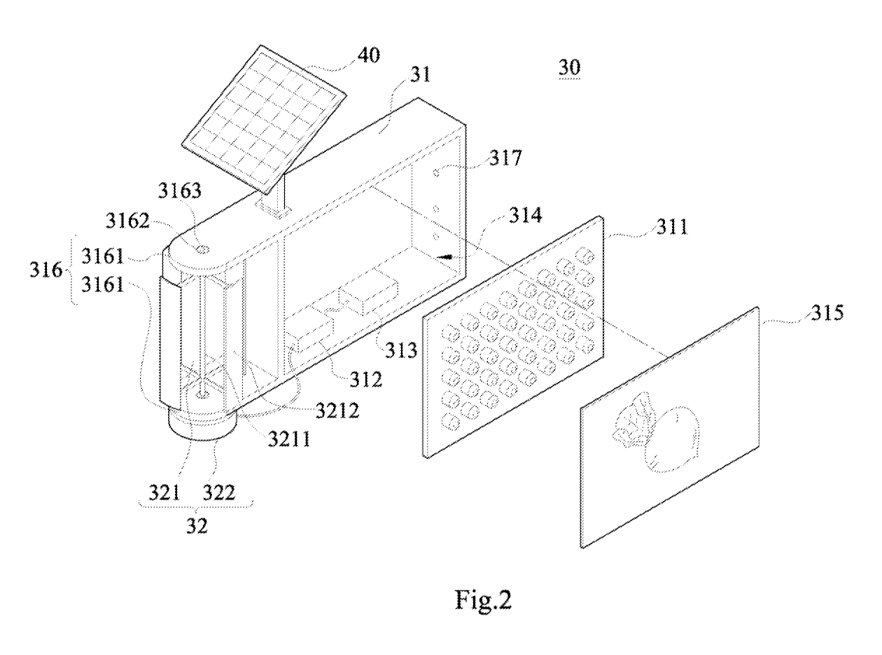

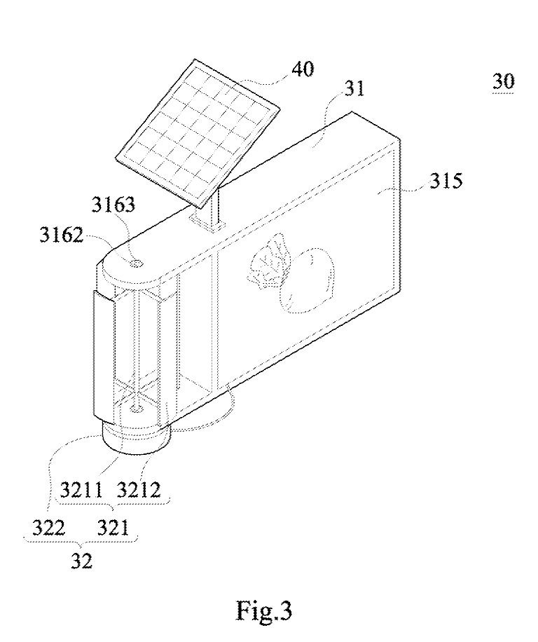

With reference to FIGS. 2 and 3 for an exploded view and a perspective view of a preferred embodiment of the present invention respectively, the green energy sign lamp 30 includes a lamp box 31 and a wind power generation device 32.

The lamp box 31 comes with a hollow box structure for containing an LED light emitting source 311, a current conversion module 312 and a battery 313, and the current conversion module 312 is electrically coupled to the LED light emitting source 311 and the battery 313. In the figures, the LED light emitting source 311 includes a plurality of light emitting diodes (not shown in the figures), and a light emitting surface 314 penetrated through a side of the lamp box 31 and provided for installing an advertising billboard 315 including a pattern or text on the light emitting surface 314. In addition, the lamp box 31 includes a support stand 316 and a fixed portion 317 disposed on two opposite sides of the lamp box 31 respectively, wherein the support stand 316 includes two symmetric fixed plates 3161, and each of the fixed plates 3161 includes a through hole 3162, and a bearing 3163 installed in the through hole 3162. The fixed portion 317 is provided and fixed onto a wall or combined with other clamping devices and fixed onto a rod.

The wind power generation device 32 is installed between the fixed plates 3161, and the wind power generation device 32 further comprises a vane wheel 321 and an electricity generator 322, and the vane wheel 321 includes a shaft 3211 and a plurality of vanes 3212, wherein both ends of the shaft 3211 are axially installed in a bearing 3163 of the fixed plates 3161 as shown in the figure, and the electricity generator 322 is installed at the bottom of the fixed plate 3161, such that the shaft 3211 is connected to the electricity generator 322, but the invention is not limited to such arrangement only. The vane wheel 321 is rotated by wind to start the electricity generator 322 to generate electric energy. In addition, the wind power generation device 32 is electrically coupled to the current conversion module 312, such that mechanical energy can be generated to drive the electricity generator 322 to operate and generate the electric energy, after the vane wheel 321 of the wind power generation device 32 installed on a side of the lamp box 31 is rotated by wind. Current is converted (from AC to DC) by the current conversion module 312 to drive the LED light emitting source 311 to emit light directly and light up the advertising billboard 315, or store unused electric energy into the battery 313. When the wind power generation device 32 is not generating electricity (in a condition without wind or having insufficient wind), there is still enough electric energy provided for driving the LED light emitting source 311 to emit light.

The green energy sign lamp 30 of the present invention can be combined with a solar power generation device 40 for its use, and the solar power generation device 40 is installed at the top of the lamp box 31, and electrically coupled to the current conversion module 312 for absorbing solar energy from the sunlight, and the solar energy is used for generating electric energy to start up the LED light emitting source 311 to emit light, or store unused electric energy into the battery 313. In the meantime, the present invention can use both wind power and solar energy to generate electric energy, so as to expand the scope of applicability of the present invention.

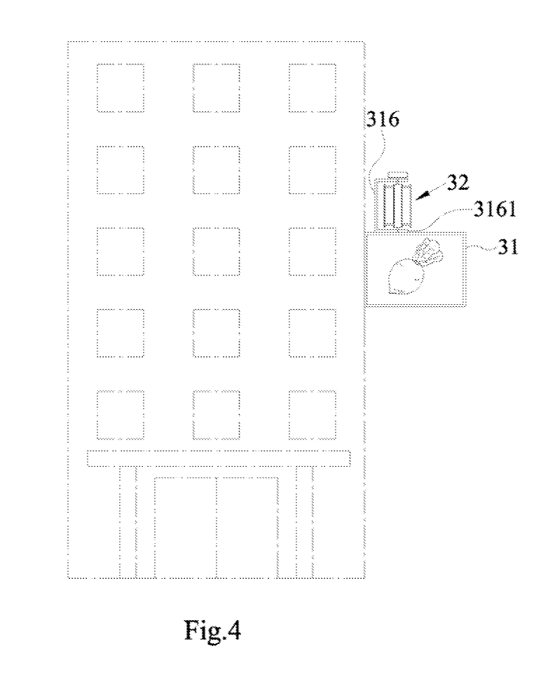

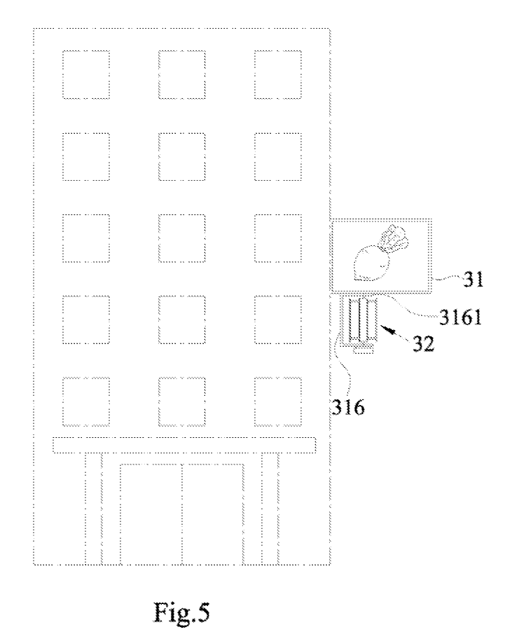

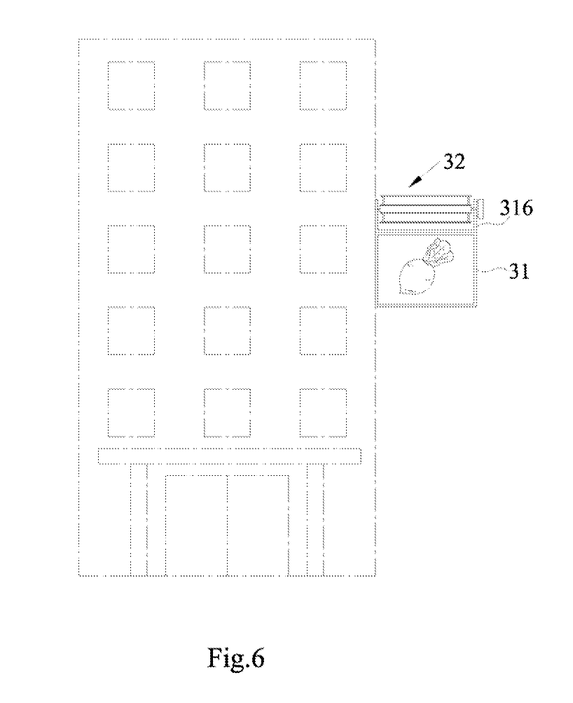

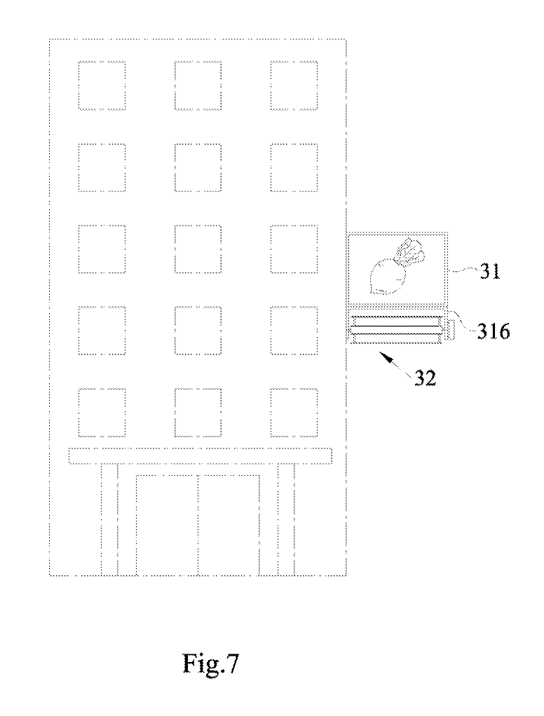

To cope with various different sites or spaces, the position for installing the support stand 316 of the lamp box 31 of the present invention can be varied. For example, the support stand 316 is installed on a lateral edge of an adjacent connecting side of the fixed portion 317, but basically the number of components remains unchanged. With reference to FIGS. 4 to 7 for schematic views of preferred embodiments of the present invention respectively, FIG. 4 shows that the support stand 316 is installed at the top of the lamp box 31, and the fixed plate 3161 at the bottom of the support stand 316 is disposed on an external surface of the lamp box 31, such that an opening of the support stand 316 is aligned in the same direction of an opening of the support stand 316 as shown in FIG. 3, and the direction for installing the wind power generation device 32 is the same as the original direction. In FIG. 5, the support stand 316 is installed at the bottom of the lamp box 31, and the fixed plate 3161 at the top of the support stand 316 is disposed on an external surface of the lamp box 31, and an opening of the support stand 316 is aligned in the same direction of the installation of the wind power generation device 3 as shown in FIG. 4. In FIG. 6, the support stand 316 is installed at the top of the lamp box 31, and the axial direction of the wind power generation device 32 is perpendicular to the wind power generation device 32 as shown in FIG. 4. In other words, the wind power generation device 32 and the lamp box 31 are installed horizontally. In FIG. 7, the support stand 316 is installed at the bottom of the lamp box 31, and the axial direction of the wind power generation device 32 is perpendicular to the wind power generation device 32 as depicted in FIG. 4. In other words, the wind power generation device 32 and the lamp box 31 are installed horizontally. The aforementioned embodiments provide more flexibility to the design and cope with the aesthetic requirements of different designs, and the lamp can be adjusted according to the requirements of the installation site. Obviously, the invention not only facilitates the installation and application, but also reduces the construction cost of the sign lamp.

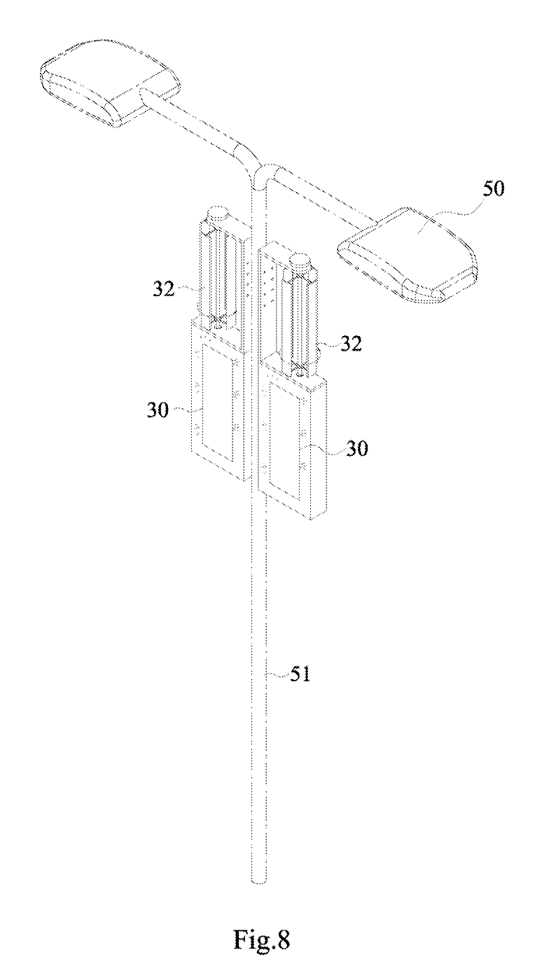

In FIG. 8, one or more green energy sign lamps 30 of the present invention can be fixed to a rod 51 of a road lamp 50, or other types of rods. In FIG. 8, two green energy sign lamps 30 are installed side by side along both sides of the rod 51 respectively, and the wind power generation device 32 can be installed in the ways in accordance with embodiments as shown in FIGS. 4 to 7, and provided for driving the lamp box 31 disposed on the rod to emit light without the need of utilizing an external electric power source. The present invention not only provides a simple and convenient installation, but also reduces the cost of power consumption and enhances the advertising effect at night time.

While the invention has been described by device of specific embodiments, numerous modifications and variations could be made thereto by those generally skilled in the art without departing from the scope and spirit of the invention set forth in the claims.

In summation of the description above, the present invention can improve over the prior art and comply with the patent application requirements, and thus is duly filed for patent application.

What is claimed is:

1. A green energy sign lamp, comprising:
a lamp box, including an LED light emitting source, at least one advertising billboard, a current conversion module and a battery, and the LED light emitting source, the current conversion module and the battery being installed in the lamp box, and the current conversion module being electrically coupled to the LED light emitting source and the battery, and the advertising billboard being installed on a side of the lamp box, and a lateral side of the lamp box having a support stand and a fixed portion; and
a wind power generation device, axially installed in the support stand, and electrically coupled to the current conversion module;
therefore, the wind power generation device is operated by wind to generate electric energy to start up the LED light emitting source and light up the advertising billboard, or store the electric energy into the battery.

2. The green energy sign lamp of claim 1, wherein the support stand is installed on a lateral edge of a symmetrical side of the fixed portion.

3. The green energy sign lamp of claim 1, wherein the support stand is installed on a lateral edge of an adjacent connecting side of the fixed portion.

4. The green energy sign lamp of claim 1, wherein the support stand includes two symmetric fixed plates provided for installing the wind power generation device between the two fixed plates.

5. The green energy sign lamp of claim 2, wherein the support stand includes two symmetric fixed plates provided for installing the wind power generation device between the two fixed plates.

6. The green energy sign lamp of claim 3, wherein the support stand includes two symmetric fixed plates provided for installing the wind power generation device between the two fixed plates.

7. The green energy sign lamp of claim 1, wherein, the wind power generation device further comprising a vane wheel and an electricity generator, and the vane wheel including a shaft and a plurality of vanes, and the shaft being coupled to the electricity generator, such that the vane wheel is rotated to start up the electricity generator to generate electric energy.

8. The green energy sign lamp of claim 1, further comprising a solar power generation device electrically coupled to the current conversion module, and sunlight being used for generating electric energy to start up the LED light emitting source to emit light or store the electric energy into the battery.

9. The green energy sign lamp of claim 8, wherein the solar power generation device is installed at the top of the lamp box and provided for absorbing solar energy in the sunlight.
